(19) United States
(12) Patent Application Publication
(10) Pub. No.: US 2006/0082540 A1
(43) Pub. Date: Apr. 20, 2006

(54) Data input system

(76) Inventor: Michael Anthony William Prior, Shrewsbury (GB)

Correspondence Address: JOHN V STEWART, 1308 HENRY BALCH DRIVE, ORLANDO, FL, 32810, US

(21) Appl. No.: 10/541,345

(22) PCT Filed: Jan. 9, 2004
(86) PCT No.: PCT/GB04/00115

§ 371 Date: Jul. 5, 2005

(30) Foreign Application Priority Data
Jan. 11, 2003 (GB) 0300798.6
Sep. 17, 2003 (GB) 0321772.6

(51) Int. Cl. G09G 5/00

(52) U.S. Cl. 345/156

(57) ABSTRACT

A data input system, with which a user can input letters of an alphabet comprises: a system (112,108) for enabling the user to select one of four options and, for each selected option, to select one of eight directions; a system (114,110) for detecting the option and direction selected by the user; and a decoder (116) responsive to the detected option and direction and operable to interpret each of a number of combinations of such an option and such a direction, equal to the number of letters in the alphabet, as a respective letter of the alphabet. Directions may be selected by, for example, operating an eight-way joystick, making directional gestures on a touch-sensitive surface, or pressing different combinations of keys in a key array. Options may be selected by for example, operating an four-way joystick, pressing one or more shift keys and/or by providing more than one direction selection system so that the user can select which direction selection system to use for a particular letter. Compared with conventional systems, the data input system does not require so frequent relocation of the user's finger (or fingers or thumb(s) or a stylus or the like held by the user) when inputting letters of an alphabet.

This invention relates to a data input system and to an electronic apparatus (such as a mobile telephone, PDA or computer) having such a data input system.

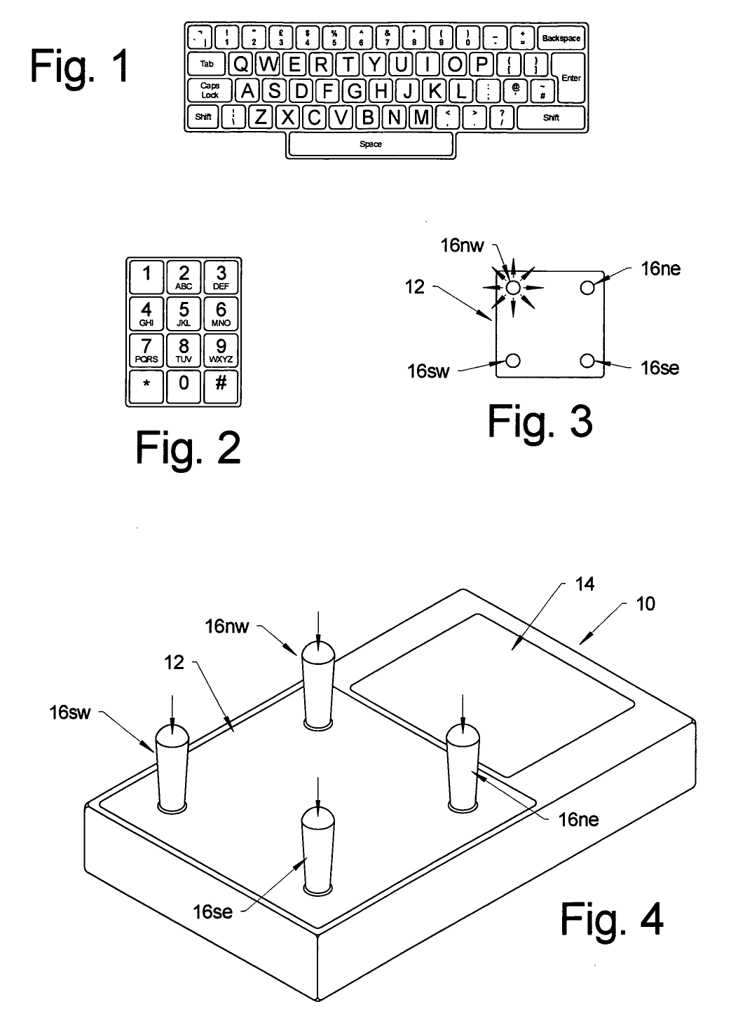

Conventionally a computer uses a QWERTY keyboard of twenty-six or more keys. This keyboard uses a separate key for each letter of the alphabet “A” to “Z” and may also use separate keys for numbers “0” to “9”, and for various punctuation marks and to control modes. FIG. 1 shows a typical layout. The layout of the alphabet keys derives from the earliest mechanical typewriters. The QWERTY keyboard uses different modes to access different characters from the same key. Typically a shift mode is used to access letters of the other case and additional punctuation marks. The usability of the computer QWERTY keyboard has the following drawbacks. Firstly, the requirement for separate keys for each letter means that there needs to be a minimum of twenty-six keys and in practice often many more together with the practical requirement that the keys need to be spaced far enough apart to be individually activated, which implies a minimum size to the overall keyboard. This minimum size may not be accommodated in small devices. Secondly, the arrangement of the letters is not a natural one, and significant learning and practice are required to become familiar with the layout. The ability to use a QWERTY keyboard without looking (touch typing) is considered a recognisable skill and qualification. Many users never become fully familiar with the layout and rely on visual inspection to locate the correct key.

Conventionally a mobile telephone uses a numeric keyboard with 10 or more keys. This keyboard uses a separate key for each number “0” to “9”. FIG. 2 shows a typical layout. When the device is in text mode, each key may be used to generate a number of different characters by pressing the key a number of times within a short time interval. The assignment of the letters “A” to “Z” to the number keys is based on the alphabet sequence and each number key may have zero or three or four different letters assigned to it. The usability of the mobile telephone numeric keyboard has the following drawbacks. Firstly, the requirement for separate keys for each number means that there needs to be a minimum of ten keys and in practice often more together with the practical requirement that the keys need to be spaced far enough apart to be individually activated, which implies a minimum size to the overall keyboard. This minimum size may not be accommodated in very small devices. Secondly, the assignment of multiple letters to each key means that a key may need to be pressed up to four times to obtain one letter of the alphabet. In addition, when the next letter required is allocated to the same key as just used then input must be paused to differentiate between a repeat press to select a different letter and a new press to select the next letter. This slows the input speed to the device. Thirdly, the assignment of the letters to the number keys requires learning and practice to become familiar with the layout. Many users never become fully familiar with the layout and rely on visual inspection to locate the correct key.

Some attempts have been made in the past to reduce the number of keys required for inputting the English alphabet to less than twenty-six, while not requiring more than one operation of a key to input at least some of the letters. Patent document US-A-2002/0140679 describes a keyboard in which rocker switches can each be depressed to the left, to the right or centrally to input three letters. It is therefore necessary to use nine rocker switches to represent all 26 letters of the English alphabet. For the purposes of this specification, such a keyboard can be thought of as having nine input elements each of which can be actuated in three different ways. Also, patent document WO-A-02/063455 describes an alphanumeric keyboard in which each number key is formed as a joystick that can also be moved up, down, left and right to input four letters. With such an arrangement it is necessary to employ seven joysticks in order to represent all twenty-six letters of the English alphabet. For die purposes of this specification, such a keyboard can be thought of as needing seven input elements each of which can be actuated in four different ways. In the case where the user is employing only one finger to input letters with these known arrangements, in order to input a particular letter, it is necessary for the user (i) to determine which input element needs to be actuated, (ii) to move their finger to the appropriate input element (if their finger is not already at that input element), (iii) to determine in which way the input element needs to be actuated, and (iv) to actuate the input element accordingly. An experienced user may do this ‘subconsciously’, and step “iii” may overlap step “i” and/or step “ii”. Step “ii” may be omitted if the user's finger is already at appropriate input element. However, when inputting a string of letters with these known arrangements using a single finger, simplistically speaking there is an 8-in-9 (89%) probability that the finger will need to be moved to a different input element after each letter is input in the arrangement of US-A-2002/0140679, and a 6-in-7 (86%) probability that the finger will need to be so moved in the arrangement of WO-A-02/063455. If using two fingers to input a string of letters, the user needs to perform the additional step of determining which finger to use, but the probabilities that a finger will need to be moved to a different input element after each letter is input are then reduced (simplistically speaking) to 7-in-9 (78%) in the case of US-A-2002/0140679 and 5-in-7 (71%) in the case of WO-A-02/063455.

The aim of at least some embodiments of the present invention is to provide a data input system that does not require so frequent relocation of the user's finger (or fingers or thumb(s) or a stylus or the like held by the user) when inputting letters of an alphabet. In this specification, the term “finger” is intended to include not only a finger, but also a thumb, or a pointer or stylus held by die user, unless the context requires otherwise.

In accordance with a first aspect of the present invention, there is provided a data input system with which a user can input letters of an alphabet, comprising: a keypad having an array of three columns and at least three rows (and preferably four rows) of numeric keys, and four further keys each disposed between a respective four of the numeric keys such that the user can operate each of the further keys in combination with one or two of the respective four adjacent surrounding numeric keys; and decoding means operable to interpret operation of the further keys each in combination with one or two of the respective four surrounding numeric keys as representing respective letters of the alphabet. Therefore, in the case where the user is employing only one finger to input a string of letters, simplistically speaking there is only a 3-in-4 (75%) probability that the finger will need to be moved to a different further key after each letter is input. In the case where the user is employing two fingers, the probability is reduced to 1-in-2 (50%). It is envisaged that this reduction in the frequency of relocation of the user's finger(s) will significantly increase the speed with which letters can be input.

Preferably, the numeric keys are arranged to provide a different feel to the user than the further keys. For example, the further keys may be raised relative to the numeric keys and/or be stiffer in operation.

In an example layout that will be described in detail below, twelve such numeric keys in a 3×4 layout of a conventional mobile telephone keypad are interspersed by the four further keys. This increases the number of keys compared with the conventional mobile telephone keypad. However, the ability of the user to place their finger on one of the four further keys and then press that further key while simultaneously rocking their finger in one of eight directions so as also to depress the required one or two numeric keys enables user operability and push-button density to be maintained. This provides means for input of letters, each by a single operation, that need be no larger than a conventional numeric keypad. This is clearly faster and more efficient than a conventional mobile phone keypad which requires from one to four operations to input each letter. The keypad can also clearly be made much smaller than a conventional QWERTY keyboard and hence is more suitable for small sized devices. Each one-in-eight direction selection is, because of the directional nature, intuitively distinctive. Each one-in-four option is memorable because each selection is from such a small number of possibilities, and further when arranged in a two-by-two array the options become, because of the positional nature, intuitively distinctive. Thus the option and direction combinations are distinctive and memorable and do not rely on visual inspection in order to find the correct key from a long list or relatively large array of seemingly identical keys.

The decoding means is preferably also operable to interpret operation of the numeric keys as representing respective digits of the denary number system.

The present invention is not limited to the use of keys as input elements, and in accordance with a second aspect of the present invention there is provided a data input system with which a user can input letters of an alphabet, comprising: a surface over which the user can move one of their fingers or other pointer, detecting means for detecting over which of four portions of the surface such movement is made and in which of eight directions such movement is made; and decoding means responsive to the detected portion and direction and operable to interpret each of a number of combinations of the portions and directions, equal to the number of letters in the alphabet, as a respective letter of the alphabet. Again, in the case where the user is employing only one finger to input a string of letters, simplistically speaking there is only a 3-in-4 (75%) probability that the finger will need to be moved to a different portion of the surface after each letter is input, and in the case where the user is employing two fingers; the probability is reduced to 1-in-2 (50%). Again, each letter is obtained by a single operation and the positional and directional nature of each selection makes them intuitively distinctive. The surface and detecting means may conveniently be implemented using a touch screen.

More generally, in accordance with a third aspect of the present invention, there is provided a data input system with which a user can input letters of an alphabet, comprising: selecting means for enabling the user to select one of four options and, for each selected option, to select one of eight directions (which are preferably equi-angularly spaced and more preferably are the orthogonal left, up, right and down directions, and the four diagonal directions therebetween); detecting means for detecting the option and direction selected by the user; and decoding means responsive to the detected option and direction and operable to interpret each of a number of combinations of such an option and such a direction, equal to the number of letters in the alphabet, as a respective letter of the alphabet.

In a first variant, the selecting means comprises four direction-selecting means (such as joysticks, touch screen portions or key arrays) each for enabling the user to select one of eight directions. Therefore the user can select the option by choosing the direction selecting means that they use for inputting a particular letter. Again, in the case where the user is employing only one finger to input a string of letters, simplistically speaking there is only a 3-in-4 (75%) probability that the finger will need to be moved to a different direction-selecting means after each letter is input, and in the case where the user is employing two fingers, the probability is reduced to 1-in-2 (50%). The four direction-selecting means may be separate, for example separate joysticks.

In a second variant, the selecting means comprises: option-selecting means (such as two or four pushbuttons, a four-way joystick, or a couple of tilt switches) for enabling the user to select one of four options; and direction-selecting means (such as a single eight-way joystick, a single touch screen portion or a single eight-way rocker switch) for enabling the user to select one of eight directions. In the case where the user employs a finger of one hand on a four-way joystick as the option-selecting means and employs a finger of the other hand on an eight-way joystick as the direction-selecting means to input a string of letters, it will be appreciated that the user does not need to relocate their fingers at all after each letter is input.

In a third variant, the selecting means comprises: option-selecting means (such as a shift key) for enabling the user to select one of two options; and two direction-selecting means (such as a pair of touch screen portions or a pair of eight-way rocker switches) each for enabling the user to select one of eight directions. However, each direction-selecting means preferably comprises an eight-way joystick, and one or both joysticks may have a shift function (for example by squeezing the joystick or pressing it downwards) to provide the option-selecting means. In this case, if the user employs a finger of one hand on one of the joysticks and a finger of the other hand on the other joystick, it will be appreciated that the user does not need to relocate their fingers at all after each letter is input.

At least a portion of the selecting means that enables the user to select at least one of the eight directions when one of the options is selected may be the same as, or integral with, at least a portion of the selecting means that enables the user to select at least one of the eight directions when at least one other of the options is selected, so as to reduce the number of components that are required or manufacturing complexity. For example, a single touch screen may be employed for direction selection when any of the four options is selected, or, as in the case of the first aspect of the invention in which the selecting means comprises a numeric keypad having an array of three columns and at least three rows of numeric keys, and four further keys each disposed between a respective four of the numeric keys, some of the numeric keys are used for more than one of the options.

Furthermore, at least a portion of the detecting means that detects at least one of the eight directions selected by the user when one of the options is selected may be the same as, or integral with, at least a portion of the detecting means that detects at least one of the eight directions selected by the user when at least one other of the options is selected, again so as to reduce the number of components that are required or manufacturing complexity. For example, there may be a common interface for the touch screen, or a shared key may have a shared key switch.

At least in the first variant of the third aspect of the invention, the options are arranged in a two-by-two array. In other words, the four joysticks, four touch screen portions or four key sub-arrays are arranged in a two-by-two array. This is a compact arrangement that proves convenient to operate for example by one or both fingers or thumbs and enables further advantages detailed below. Again, the positional and directional nature of each selection sakes them intuitively distinctive. In this case, the options for inputting the vowels of the alphabet may be arranged in the same column or the same row of the array, and the directions for inputting the vowels of the alphabet (for example “A”, “E”, “I”, “O” and “U” in the English alphabet, or “A”, “E”, “I”, “O”, “Y” and “Ω” in the Greek alphabet) have a common orthogonal component. The vowels can therefore be considered to be aligned. Furthermore, by arranging the other letters of the alphabet in alphabetical order, it is easy to evaluate the required options and directions for the other letters by knowing the sequence of the letters in the alphabet. This facilitates the user becoming quickly familiar with the layout and being able to locate the position of any letter by the simple knowledge of the order of the letters in the alphabet and without the necessity to rely on visual inspection.

The selecting means, or each direction-selecting means, preferably comprises a, or a respective, input element that has a normally-unactuated state and that is manually actuable in the eight directions to eight actuated states. For example, as in the case of joysticks, each element may be arranged to be urged by the user in the eight directions and further includes means for detecting the general direction in which the respective manually-operable element is urged. Thus a keyboard layout of just four joysticks may be used to represent, for example, the twenty-six letters “A” to “Z” of the English alphabet and at least six other values. Consequently the overall size may be considerably smaller than an arrangement using more input elements given the same spacing between elements. As another example, as in the case of touch screen portions, each element may comprise a respective surface portion over which the user can move one of their fingers or other pointer in the eight directions and means for detecting the general direction in which the finger or pointer is moved over the respective surface portion. The system may therefore be arranged so that the user can drag a finger across any of the four portions of the touch screen in any of eight directions in order to input the twenty-six letters “A” to “Z” of the English alphabet and at least six other values. As a further example, as in the case of the numeric keypad with the further keys, each element may comprise a respective primary manually-operable sub-element and four secondary manually-operable sub-elements arranged around that primary sub-element such that the primary sub-element and any one, or adjacent two, of the secondary sub-elements can be operated in a combination by the user and further includes means for detecting which of the eight combinations of the sub-elements is actuated.

In accordance with a fourth aspect of the present invention, there is provided a data input system comprising four input elements, each having a normally-unactuated state and each being manually actuable to each of at least eight actuated states, and a decoder operable in an alphabetic mode in which the decoder is operable to interpret each of a first number of the actuated states, equal to the number of letters in an alphabet, as representing a respective letter of that alphabet.

In accordance with a fifth aspect of the present invention, there is provided a data input system comprising four input elements, each having a normally-unactuated state and each having a portion that is manually operable by a user to place the input element in each of at least eight actuated states, and a decoder operable in an alphabetic mode in which the decoder is operable to interpret each of a first number of the actuated states, equal to the number of letters in an alphabet, as representing a respective letter of that alphabet.

In accordance with a sixth aspect of the present invention, there is provided a data input system comprising four input subsystems, each being manually operable by a user to each of at least eight actuated states, and a decoder operable in an alphabetic mode in which the decoder is operable to interpret each of a first number of the actuated states, equal to the number of letters in an alphabet, as representing a respective letter of that alphabet.

At least some of said first number of actuated states may each have at least one derived actuated state associated therewith (such as a held operation of the input element), and the decoder may be operable to interpret such a derived actuated state as a variant of the respective letter, such as a double letter, an accented letter or the uppercase form of a lowercase letter.

In accordance with a seventh aspect of the invention, there is provided an electronic apparatus such as a mobile telephone, PDA or computer having a data input system, according to any of the first to sixth aspects of the invention, for inputting data to the apparatus.

Specific embodiments of the present invention will now be described, purely by way of example, with reference to FIGS. 3 to 19 of the accompanying drawings, in which:

FIG. 1 shows a layout of a conventional computer QWERTY keyboard;

FIG. 2 shows a layout of a conventional mobile telephone numeric keyboard;

FIG. 3 shows a layout of a data input pad of a first embodiment of the invention;

FIG. 4 is a schematic isometric view, on a larger scale, of a mobile telephone having the data input pad of FIG. 3;

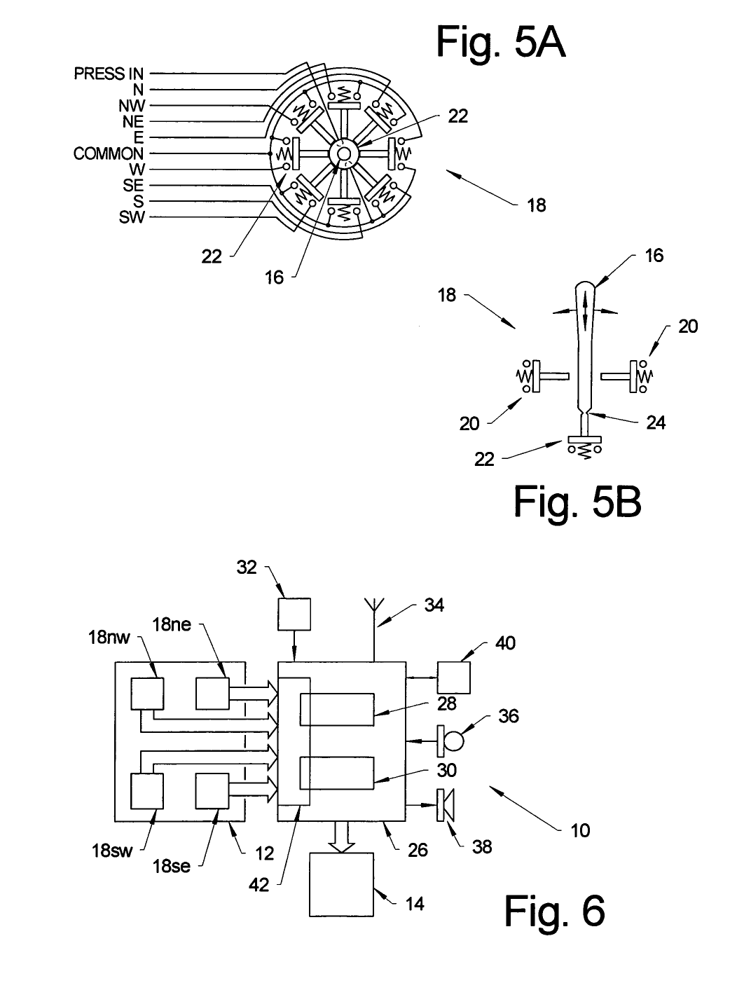

FIG. 5A is a horizontal cross-section of a nine-way joystick used in the data input pad of FIG. 3;

FIG. 5B is a vertical slice cross-section the nine-way joystick of FIG. 5A;

FIG. 6 is a schematic block diagram of the mobile telephone of FIG. 4;

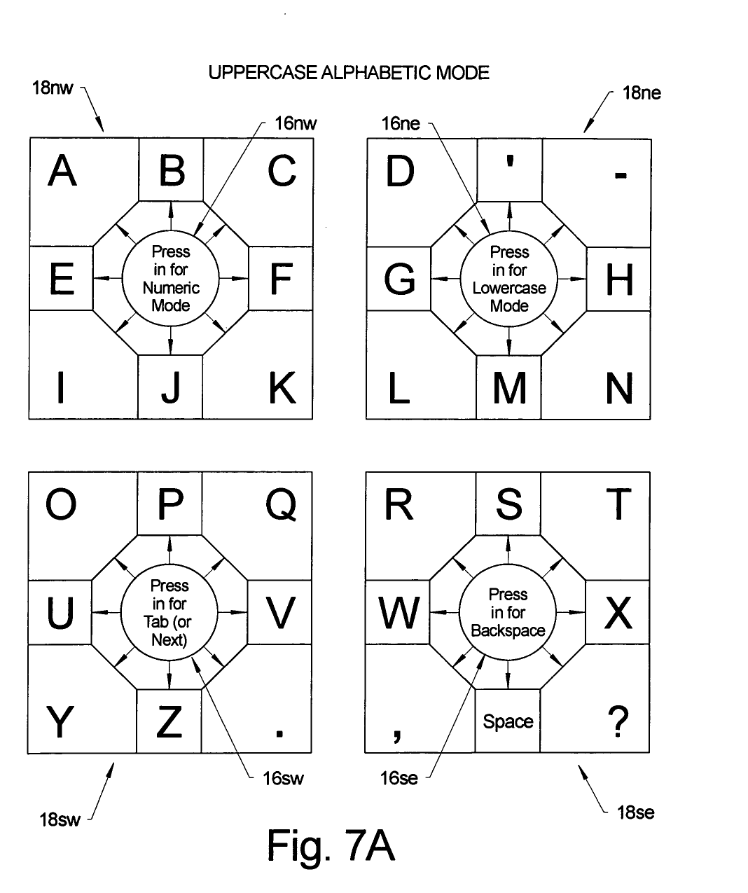

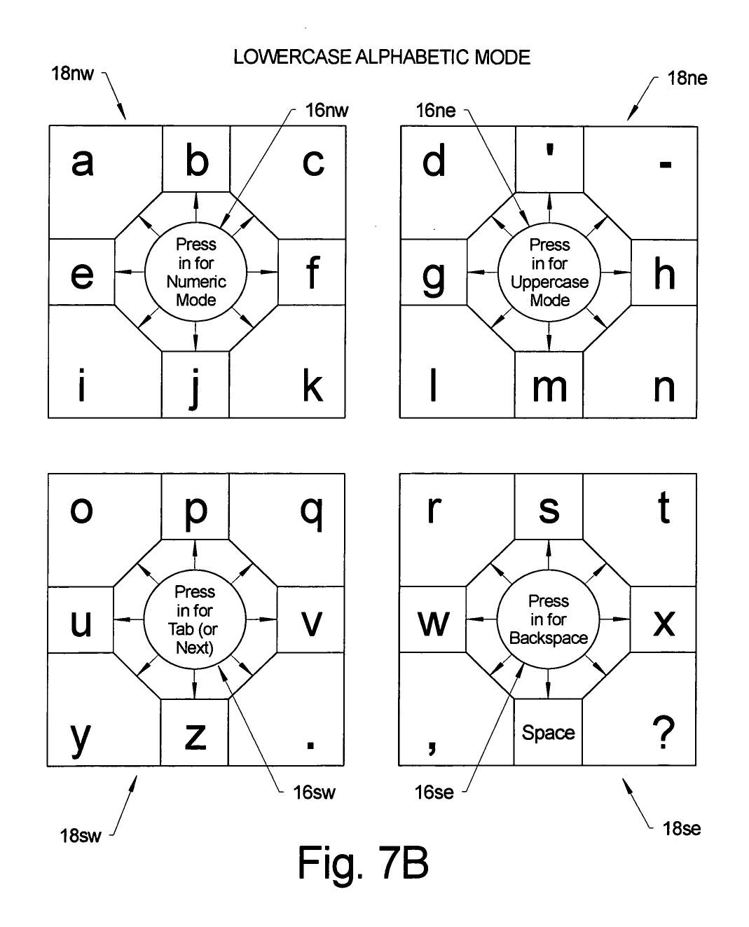

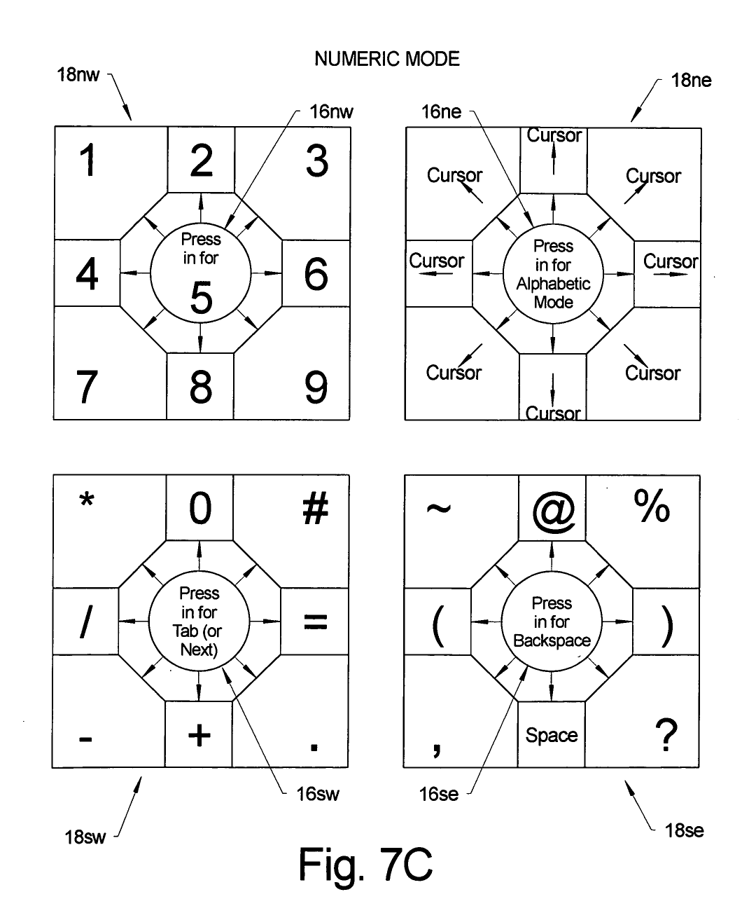

FIG. 7A shows an example layout for an uppercase alphabetic mode of the data input pad;

FIG. 7B shows an example layout for lowercase alphabetic mode of the data input pad;

FIG. 7C shows an example layout for numeric mode of the data input pad;

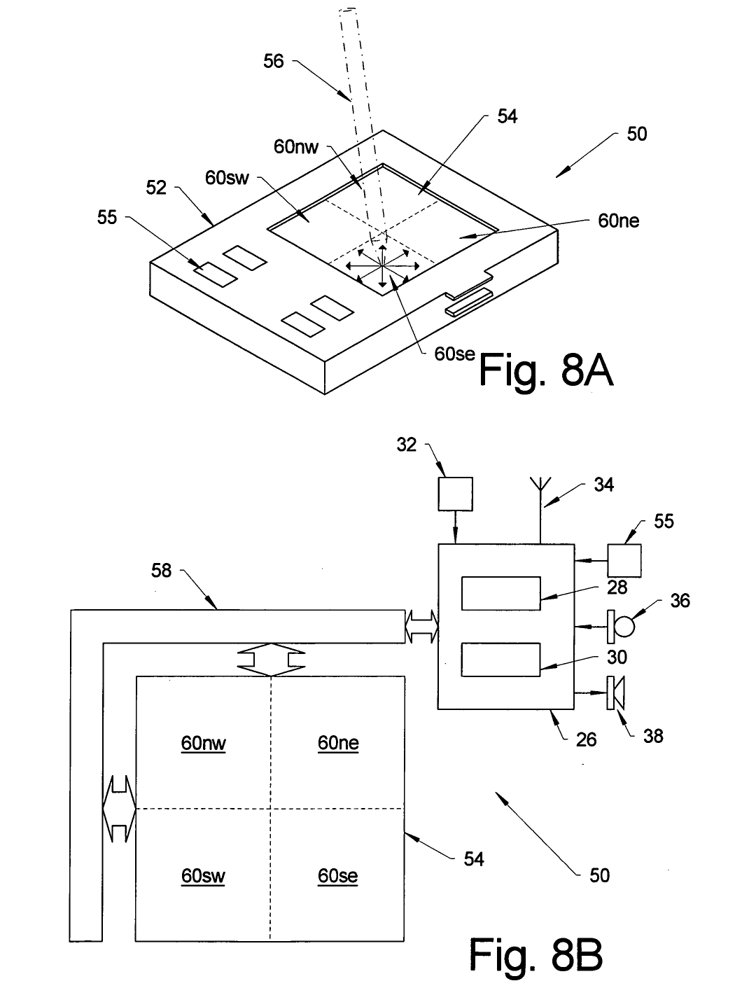

FIG. 8A is a schematic isometric view of a device having a data input pad of a second embodiment of the invention;

FIG. 8B is a schematic block diagram of the device of FIG. 8A;

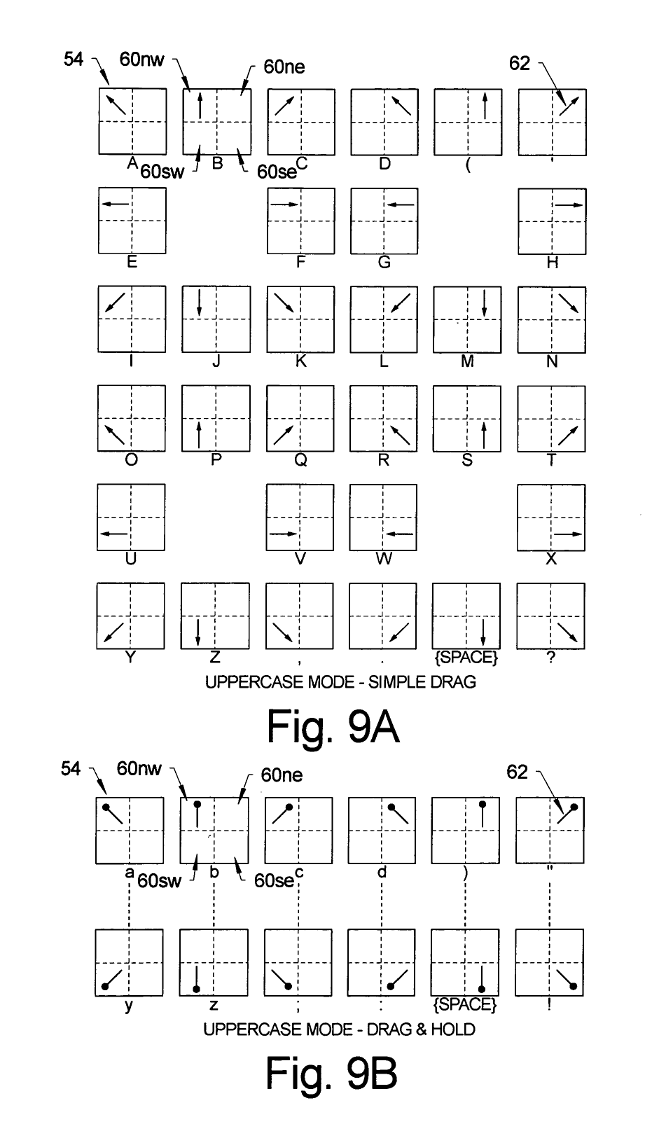

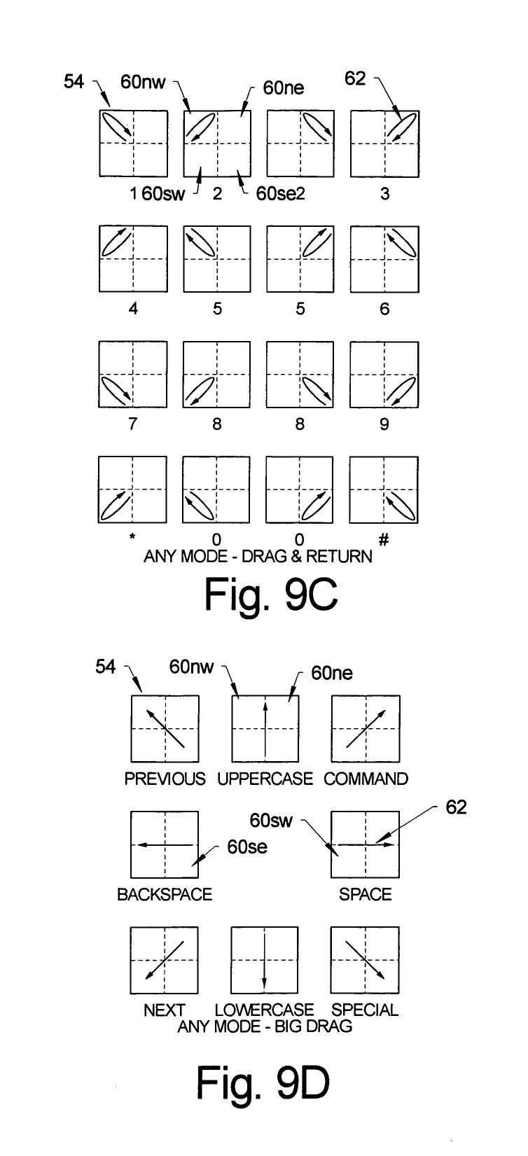

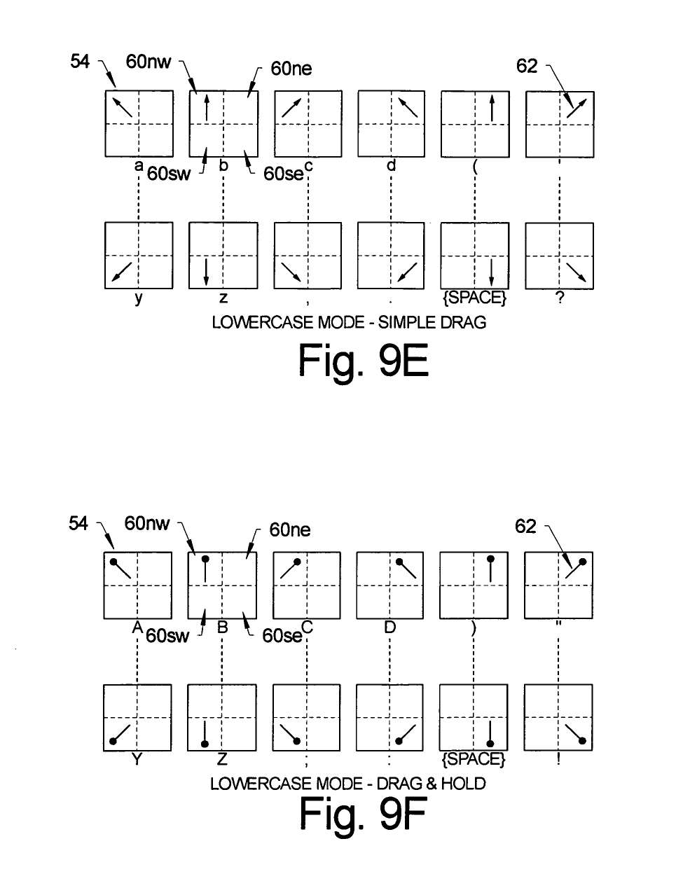

FIGS. 9A-F are tables showing examples of actuations of the data input pad of FIGS. 8A and 8B;

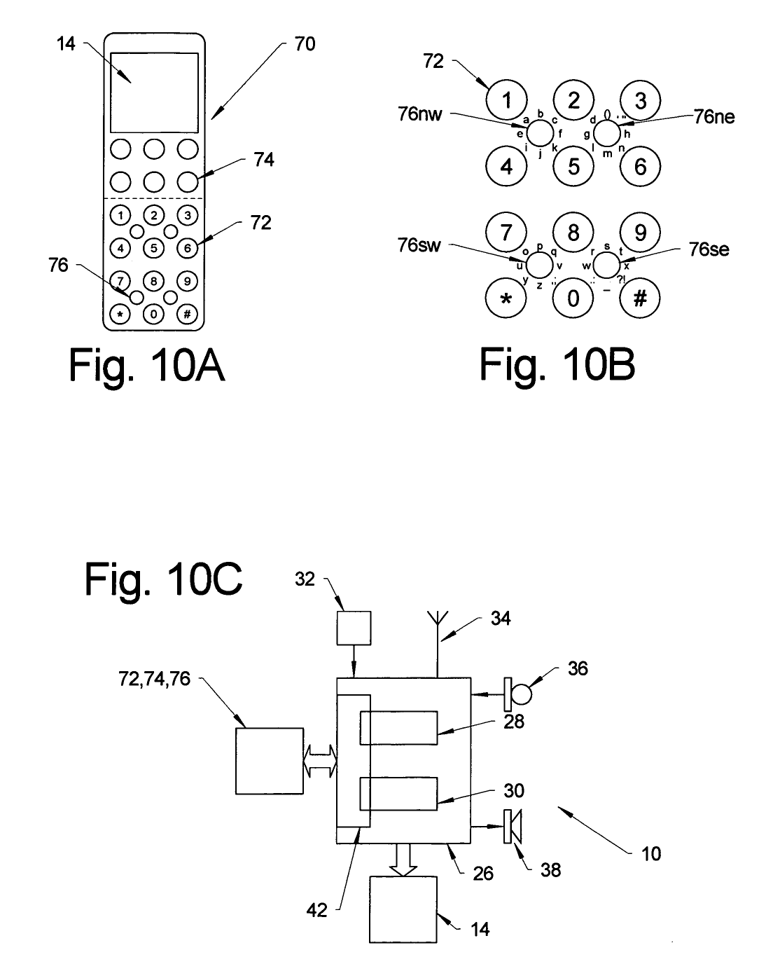

FIG. 10A is a schematic front view of a mobile telephone having a data input pad of a third embodiment of the invention;

FIG. 10B shows on a larger scale the data input pad of FIG. 10A;

FIG. 10C is a schematic block diagram of the mobile telephone of FIG. 10A;

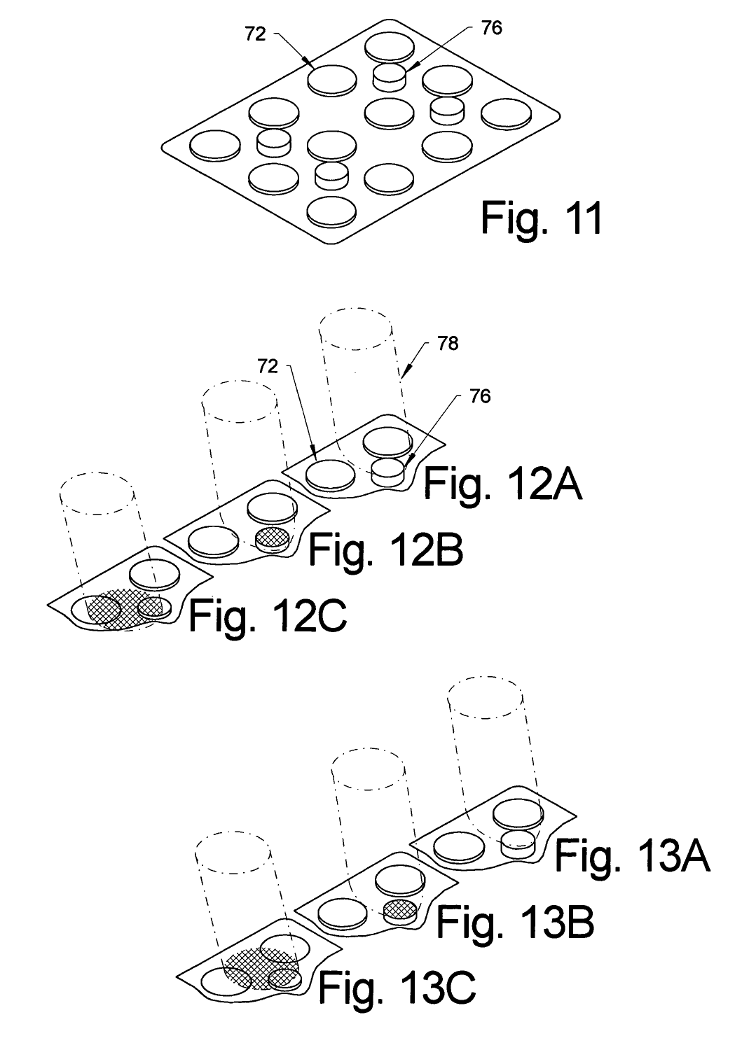

FIG. 11 is an isometric view of the data input pad of FIG. 10A;

FIGS. 12A-C are isometric views of a portion of FIG. 11, showing different stages in the input of one letter;

FIGS. 13A-C are isometric views of a portion of FIG. 11, showing different stages in the input of another letter;

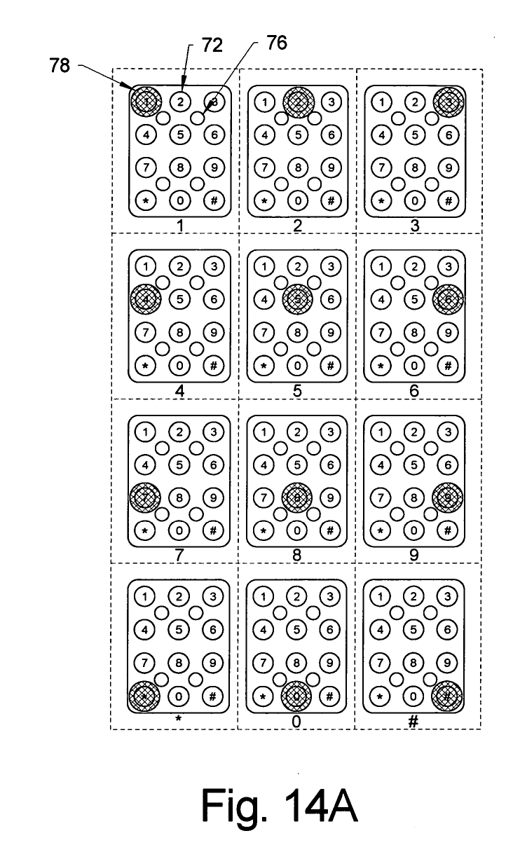

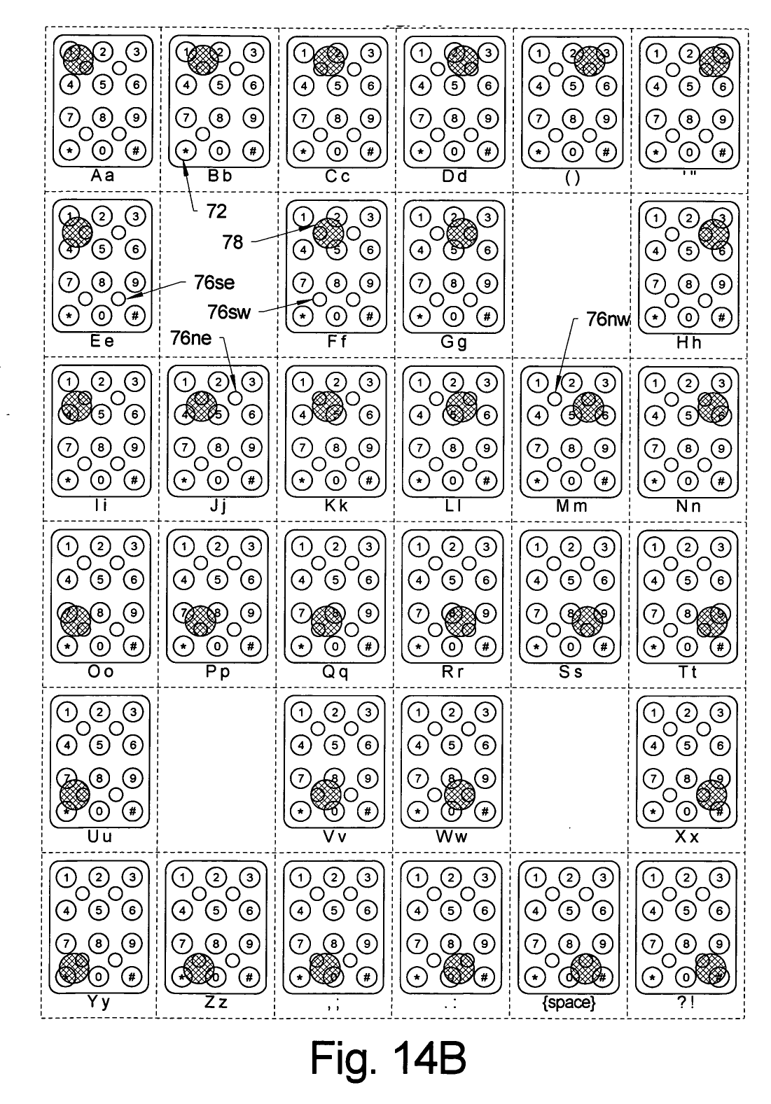

FIGS. 14A&B are tables showing examples of actuations of the data input pad of FIGS. 10A and 10B; and

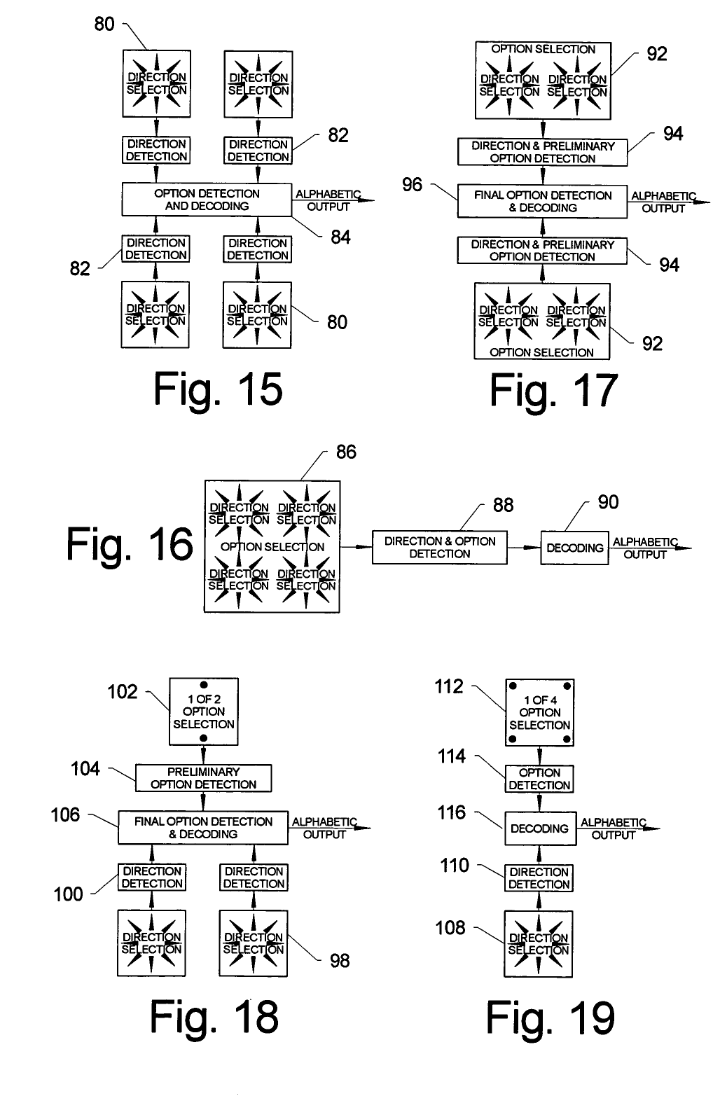

FIGS. 15-19 are block diagrams illustrating various classes of the invention.

Referring to FIGS. 3 to 6, a mobile telephone 10 has a data input pad 12 disposed on its front face below a display 14 of the telephone 10. The data input pad 12 has a 2×2 array of joysticks 16 (individually referenced 16nw,16sw,16se,16ne), each forming part of a respective switch array 18 (individually referenced 18nw,18sw,18se,18ne). Referring in particular to FIGS. 5A and 5B, each switch array 18 comprises eight normally-open momentary push-switches 20 equi-angularly arranged around the joystick 16 and a ninth normally-open momentary push-switch 22 to which the lower end of the joystick 16 is joined by an elastic hinge 24. Accordingly, when the joystick 16 is tilted up, down, left, right, up-and-left, up-and-right, down-and-left, and down-and-right (as shown by the arrows around the joystick 16nw in FIG. 3), it will close a respective one of the eight switches 20. Furthermore, when the joystick 16 is pressed in (as indicated by the vertical arrows in FIG. 4), it will close the switch 22. When the user lets go of the joystick 16, it automatically returns to its central position in which none of the switches 20,22 is closed.

Referring in particular to FIG. 6, the mobile telephone 10 also includes a main circuit 26 including a microprocessor 28 and memory 30, to which the display 14, a battery 32, an aerial 34, a microphone 36, a speaker 38 and optionally other switches and indicators 40 are connected in a conventional fashion. The main circuit 26 further includes a decoder 42, part of the functionality of which is provided by the microprocessor 28 and memory 30, to which the switch arrays 18 of the data input pad 12 are connected.

During data input, the decoder 42 and microprocessor 28 are programmed by the memory 30 so as to be operable selectably in an uppercase alphabetic mode, a lowercase alphabetic mode and a numeric mode, in which operation of each of the switches 20,22 of the switch arrays 18 can be interpreted by the decoder 42 to represent different characters or functions.

FIG. 7A shows how operations of the joysticks 16nw,16sw,16se,16ne of the four switch arrays 18nw,18sw,18se,18ne are interpreted in the uppercase alphabetic mode. The top left joystick 16nw is shown surrounded by eight of its on positions of the respective switches 20, the up-and-left position being interpreted as the uppercase letter “A”, the up position being interpreted as the letter “B” and so on with the up-and-right position, left position, right position, down-and-left position, down position and down-and-right position being interpreted as the uppercase letters “C”, “E”, “F”, “I”, “J” and “K”, respectively. Similarly, eight of the on positions of the top-right joystick 16ne are interpreted as the uppercase letters “D”, “G”, “H”, “L”, “M” and “N” and the punctuation marks apostrophe and hyphen “'”, “-”. Eight of the on positions of the bottom-left joystick 16sw are interpreted as the uppercase letters “O”, “P”, “Q”, “U”, “V”, “Y” and “Z” and the full-stop punctuation mark “.”. Eight of the on positions of the bottom-right joystick 16se are interpreted as the uppercase letters “R”, “S”, “T”, “W” and “X”, and the comma, space and question punctuation marks “,”, “ ”, “?”. The letters and other symbols for each joystick form a square, other rectangle or other parallelogram, with four symbols at the corners of the parallelogram (the diagonal directions) and four symbols at the midpoints of the edges of the parallelogram (the orthogonal directions). The symbols for each joystick may alternatively be similarly formed on a circle or ellipse. Pressing the top left joystick 16nw inwards (its ninth on state) is interpreted by the decoder 42 as a request to change to the numeric mode (see FIG. 7C). Similarly, pressing the top right joystick 16ne inwards is interpreted by the decoder 42 as a request to change to the lowercase alphabetic mode (see FIG. 7B). Pressing the bottom left joystick 16sw inwards is interpreted by the decoder 42 as a “tab” or “next” control command, and pressing the bottom right joystick 16se inwards is interpreted by the decoder 42 as a “backspace” control command.

Referring to FIG. 7B, in the lowercase alphabetic mode the decoder 42 responds to tilting actuations of the joysticks 16nw,16sw,16se,16ne in a manner exactly alike that in the uppercase alphabetic mode except that the letters of the alphabet are interpreted as lowercase letters “a” to “z” rather than the corresponding uppercase letters “A” to “Z”. Also, pressing the joysticks 16nw,16sw,16se inwards has a similar effect as in the uppercase mode. However, pressing the top right joystick 16ne inwards is interpreted by the decoder 42 as a request to change to the uppercase alphabetic mode (see FIG. 7A).

Referring to FIG. 7C, for the numeric mode, the top left joystick 16nw is shown surrounded by eight of its on positions, the up-and-left position being interpreted as the digit “1”, the up position being interpreted as the digit “2” and so on with the up-and-right position, left position, right position, down-and-left position, down position and down-and-right position being interpreted as the digits “3”, “4”, “6”, “7”, “8” and “9”, respectively. Pressing the top left joystick 16nw inwards is interpreted by the decoder 42 as the digit “5”. The up position of the bottom left joystick 16se is interpreted as the remaining digit “0”, and the other tilting positions of that joystick are interpreted as various punctuation marks, other characters or mathematical operators. The eight tilting positions of the top right joystick 16ne are interpreted by the decoder 42 as cursor movement commands in the corresponding directions, so as to move a cursor on the display 14, or, for example to navigate a ment, or hierarchical structure of menus, of options. Pressing the top right joystick 16ne inwards is interpreted by the decoder 42 as a request to change to the alphabetic mode in the case last used (see FIG. 7A or 7B), or the uppercase mode if neither alphabetic mode has previously been used. The eight tilting positions of the bottom right joystick 16se are interpreted by the decoder 42 as various punctuation marks and a space. Pressing the joysticks 16sw,16se inwards has a similar effect as in the alphabetic modes.

It will be appreciated from FIGS. 7A and 7B that the positions for the vowels A, E, I, O and U and the partial-vowel Y are aligned, in order, on the left side of the data input pad, that the consonants following a vowel are in order in the same row as that vowel, and that the positions for a particular letter are identical in the two alphabetic modes. It will also be appreciated from FIG. 7C that the positions for the digits 1 to 9 and for the “*” and “#” symbols correspond to those on a standard telephone keypad. Furthermore, it will be appreciated from FIGS. 7A to 7C that where a function, control character or punctuation mark occurs in more than one mode, its position is identical in those modes. All of these features will facilitate the learning of touch-using (as in touch-typing) of the data input pad 12.

Many modifications and developments may be made to the embodiment of the invention described above.

For example, for touch-using, the joysticks 16 may be provided on the rear face, rather than the front face, of the telephone 10, behind the display 14, enabling the size of the telephone 10 be reduced. In this case the vowels may be aligned on the right of the data input pad 12, as viewed from the rear.

Although the invention was conceived in connection with miniature data entry devices, the data entry pad may be formed of a much larger size so that it can be used in environments where the operator is required to wear gloves or mittens and cannot reliably or easily operate a conventionally-sized QWERTY or telephone keyboard.

Although the invention was conceived in connection with inputting text it may also be used to control games. In this case, the joysticks 16nw,16ne,16sw,16se may be colour-coded, for example blue, yellow, green and red, respectively, and also used in an additional object-control mode for controlling correspondingly-coloured game objects.

Although the invention was conceived in connection with inputting text, if the joysticks 16nw,16ne,16sw,16se are colour-coded, for example blue, yellow, green and red, respectively, it may also be used in an additional selection mode to select correspondingly-coloured options or links or text shown on the display 14.

Although the invention was conceived in connection with inputting text it may also be used in an additional navigation mode to navigate a menu, or hierarchical structure of menus, of options.

Although the invention was conceived in connection with inputting text it may also be used in an additional cursor-control mode to control the movement of a cursor shown on the display 14.

Although the invention was conceived in connection with mobile telephones and the like (e.g. PDAs and miniature computers), it may also be embodied in other devices, such as television or set-top-box remote controllers or game controllers. In this case, if the joysticks 16nw,16ne,16sw,16se are colour-coded, for example blue, yellow, green and red, respectively, they may also be used in additional modes for, for example, teletext selection or controlling correspondingly-coloured game objects.

The nine-way joysticks 16 may be replaced by nine-way rocker switches. Also, although each switch array 18 has been described above and shown as comprising nine individual, individually-wired, switches 20,22, other arrangements may be employed. For example, the switches may be multiplexed. The eight switches 20 of each array 18 may be replaced by four switches and additional logic circuitry or further intelligence in the decoder 42, or all nine switches 20,22 of each array may be replaced by two potentiometers or strain gauges and further intelligence in the decoder 42.

The system may be developed to allow the input of accented letters, double letters and other variants, for example by interpreting the holding of a joystick 16 in a particular position for more than a preset time, or a repeated movement of a joystick 16 within less than a preset time, as such a variant.

As is known per se in mobile telephones, the current mode may be indicated on the display 14, for example by “ABC” for the uppercase mode, by “abc” for the lowercase mode, and by “123” for the numeric mode. Also, the processor 28 may be programmed in certain circumstances (for example when a telephone number is required to be entered) to force a particular mode (for example the numeric mode) and inhibit mode changing via the data input pad 12. Furthermore, the processor 28 may be programmed in certain circumstances (for example if predictive capitalisation is being employed) to force a particular mode (for example the upper case mode at the beginning of a sentence, but lowercase mode elsewhere) but enable the mode to be changed via the data input pad 12.

The embodiment of the invention has been described with reference to the English alphabet. However, the invention may also be used with other alphabets, or selectably with more than one alphabet. For example, the following tables set out example layouts for the Greek alphabet:

Greek Uppercase Mode

| | | | | | |
|---|---|---|---|---|---|
| A | B | Γ | Δ | | |
| E | Numeric | Z | H | Lowercase | Θ |
| | Mode | | | Mode | |
| I | K | Λ | M | N | Ξ |
| O | Π | P | Σ | T | |
| Υ | Tab (or | Φ | X | Backspace | Ψ |
| | Next) | | | | |
| Ω | | . | , | Space | |

Greek Lowercase Mode

| | | | | | |
|---|---|---|---|---|---|
| α | β | γ | δ | | |
| ε | Numeric | ζ | η | Uppercase | θ |
| | Mode | | | mode | |
| ι | κ | λ | μ | υ | ξ |
| o | π | ρ | σ | τ | |
| ν | Tab (or | φ | χ | Backspace | ψ |
| | Next) | | | | |
| ω | | . | , | Space | |

Greek Numeric Mode

| | | | | | |
|---|---|---|---|---|---|
| 1 | 2 | 3 | Up-left | Up | Up-right |
| | | | Cursor | Cursor | Cursor |
| 4 | 5 | 6 | Left | Alphabetic | Right |
| | | | Cursor | Mode | Cursor |
| 7 | 8 | 9 | Down-left | Down | Down-right |
| | | | Cursor | Cursor | Cursor |
| * | 0 | # | ˜ | @ | % |
| / | Tab (or | = | ( | Backspace | ) |
| | Next) | | | | |
| - | + | . | , | Space | |

It will be appreciated that in the Greek uppercase and lowercase modes, six of the vowels, A, E, I, O, Y and Ω, are aligned on the left of the left joysticks, and the remaining vowel, H, is placed on the left position of the upper-right joystick.

Referring now to the second embodiment of the invention of FIGS. 5A to 9F, and in particular FIG. 8A, the hardware of the second embodiment may be implemented by a conventional device 50 with a touch-pad or touch-sensitive screen, such as a touchscreen PDA (e.g. Palm® PDA), a pocket PC (e.g. HP/Compaq® iPaq®) or touchscreen telephone (e.g. Sony-Ericsson P800). However, the device 50 is programmed by software to operate in a different manner to a traditional device for the input by the user of letters, numbers, other characters and certain control commands.

The device 50 has a housing 52 in the form of a tablet with a rectangular touch-sensitive liquid crystal display 54 and a few other switches 55 (such as an on-off switch) set in its front face. Referring in particular to FIG. 8B, the housing 52 contains, similarly to the first embodiment, a main circuit 26 including a microprocessor 28 and memory 30, to which a battery 32, an aerial 34, a microphone 36, a speaker 38 and the other switches 55 are connected in a conventional fashion. The housing also contains an interface circuit 58 between the touch-sensitive display 54 and the main circuit 26. In a conventional fashion, the touch-sensitive display 54 can display information provided by the microprocessor 28. Furthermore, in response to being touched, the touch-sensitive display 54 and interface circuit 58 are operable to provide to the microprocessor 28 signals indicating the fact that the touch-sensitive display 54 is being touched and the current position (for example in terms of an X-Y coordinate system of the touch-sensitive display 54) at which it is being touched. In use, the touch-sensitive display 54 is touched either by a stylus 56 held by the user or directly by the user's finger or thumb. Since the area of contact of the stylus 56, finger or thumb with the touch-sensitive display 54 will be finite, the touch-sensitive display 54, interface circuit 58 and/or microprocessor 28 may determine the touch position as being, for example, the position at which maximum pressure is applied, or the position of the centroid of the area over which a pressure greater than a threshold pressure is applied. Given that the microprocessor 28 can determine the current touch position, it can also determine the manner in which the stylus 56, finger or thumb is or is not moved over the touch-sensitive display 54, for example the speed, direction and extent of movement and whether the stylus 56, finger or thumb is being held at a particular position on the touch-sensitive display 54. As described so far, the device 50 is conventional.

The novel mode in which the device 50 is programmed to operate will now be described. The area of the touch-sensitive display 54 is considered to be divided into a 2×2 array of four quadrants 60 (60nw,60ne,60sw,60se), which are shown in FIGS. 5A and 8B as divided by dashed lines. In practice, no demarcation of the quadrants 60 need be indicated to the user, or, alternatively, demarcation lines may be actively displayed on the touch-sensitive display 54, or the surface of the touch-sensitive display 54 may be formed with ridges of other surface formations denoting the demarcation lines.

Referring now to the tables of FIG. 9A to 9F, the cells of the tables each include, for a particular mode of operation (i) a representation of the four quadrants 60 of the touch-sensitive display 54, (ii) an indication of a particular gesture 62 by the stylus 56 (or user's finger or thumb) over one or more of the quadrants 60 and (iii) the letter, number, other character or command that the microprocessor 28 is programmed to interpret that gesture 62 to represent when in that mode of operation.

Referring in particular to FIG. 9A, the gestures are represented in the drawing by an arrow and will be referred to as “simple drag” gestures. In order for the device 50 to interpret a gesture as a simple drag gesture, the stylus 56 needs to be moved primarily within a particular quadrant in a generally straight line over more that a threshold distance in less than a threshold time without any significant pause at the beginning or end of the gesture, and the device 50 is then operable to determine (i) that it is a simple drag gesture, (ii) in which of the four quadrants 60 the gesture has been made or primarily made and (iii) the general direction of the gesture resolved to ±22½°. There are therefore eight possible simple drag gestures for each quadrant 60, and thirty-two possible simple drag gestures for the whole touch-sensitive display 54. FIG. 9A shows how the microprocessor 28 is programmed to interpret these thirty-two simple drag gestures when the device 50 is in an uppercase mode. For example, a simple drag gesture in the up-and-left direction in the top-left quadrant 60nw is interpreted as the uppercase letter “A”. A simple drag gesture in the down direction in the bottom left quadrant 60sw is interpreted as the uppercase letter “Z”. In addition to enabling the twenty-six letters of the alphabet to be input, the simple drag gestures in the uppercase mode also enable five punctuation marks to be input, as shown in FIG. 9A, together with a space in response to a simple drag gesture in the down direction in the bottom-right quadrant 60se.

By comparing FIGS. 7A and 9A, the reader will note, insofar as the letters of the alphabet are concerned, the correlation between the joysticks 16nw,16ne,16sw,16se of FIG. 7A and the quadrants 60nw,60ne,60sw,60se, respectively, of FIG. 9A, and the correlation between the directions of movement of the joysticks 16nw,16ne,16sw,16se of FIG. 7A and the directions of the simple drag gestures of FIG. 9A in inputting the various letters of the alphabet. It will also be appreciated from FIG. 9A that the vowels and the semi-vowel “Y” are input by simple drag gestures having a to-the-left component in the two left quadrants 60nw,60sw. With the various quadrants and directions of simple drag gestures arranged in the logical fashion of FIG. 9A, the vowels and the half-vowel Y are arranged in order in the left column of the table, and the other letters of the alphabet are arranged in order in rows to the right of the vowel which they follow. It is believed that this arrangement of the simple drag gestures will facilitate learning.

Referring in particular to FIG. 9B, gestures are represented in that drawing by an arrow with a circular, rather than V-shaped, head and will be referred to as “drag and hold” gestures. A drag and hold gesture is similar to a simple drag gesture, except that the device 50 interprets a gesture as a drag and hold gesture if the stylus 56 is held or paused at the end of the gesture for longer than a threshold time without any significant movement. FIG. 9B shows how the microprocessor 28 is programmed to interpret twelve of these thirty-two drag and hold gestures when the device 50 is in the uppercase mode. As can be seen, although in the uppercase mode, the letter-generating gestures are interpreted as the corresponding lowercase letter. The punctuation-generating gestures are interpreted as different, but somewhat-related punctuation marks, and the space-generating gesture is still interpreted as a space.

Referring to FIG. 9C, gestures are represented in that drawing by an arrow that returns on itself and will be referred to as “drag and return” gestures. In order for the device 50 to interpret a gesture as a drag and return gesture, the stylus 56 needs to be moved primarily within a particular quadrant in a generally straight line over more that a threshold distance and then back to near the start point in less than a threshold time without any significant pause at the beginning or end of or during the gesture, and the device 50 is then operable to determine (i) that it is a drag and return gesture, (ii) in which of the four quadrants 60 the gesture has been made or primarily made and (iii) the general direction of the gesture resolved to ±45°. There are therefore four possible drag and return gestures for each quadrant 60, and sixteen possible drag and return gestures for the whole touch-sensitive display 54. FIG. 9C shows how the microprocessor 28 is programmed to interpret these sixteen drag and return gestures when the device 50 is in the uppercase mode or in a lowercase mode that will be described later. For example, a drag and return gesture initially in the up-and-left direction in the top-left quadrant 60nw is interpreted as the number “1”. A drag and return gesture initially in the down direction in the bottom left quadrant 60sw is interpreted as the number “0”. It will be noted that each of the numbers “2”, “5”, “8” and “0” can be generated by two different gestures. It will also be noted that the “*” and “#” symbols found on a conventional telephone keypad can be generated by a drag and return gesture initially in the down-and-left direction in the bottom-left quadrant 60sw (for “*”) and by a drag and return gesture initially in the down-and-right direction in the bottom-right quadrant 60se (for “#”).

Referring in particular to FIG. 9D, gestures are represented in that drawing by a long arrow and will be referred to as “big drag” gestures. A big drag is similar to a simple drag gesture, except that the stylus 56 does not need to be moved primarily within one particular quadrant, and the threshold distance for a big drag gesture is greater that the threshold distance for a simple drag gesture. For a big drag gesture, the device 50 is operable to determine (i) that it is a big drag gesture, and (ii) the general direction of the gesture resolved to ±22½°. There are therefore eight possible big drag gestures for the whole touch-sensitive display 54 and FIG. 9D shows examples of how the microprocessor 28 may be programmed to interpret them. A big drag gesture in the down direction is interpreted as a command to change to the lowercase mode to be described below. Conversely, a big drag gesture in the up direction is interpreted as a command to change to the uppercase mode described above. A big drag gesture in the right direction is interpreted as inputting a space. A big drag gesture in the left direction is interpreted as a backspace, e.g. a command to delete the last character than was input Big drag, gestures in the up-left and down-left directions may be interpreted as “previous” and “next” commands, respectively, when navigating between input fields in a dialogue. A big drag gesture in the up-right direction may be interpreted as a command to change to a command mode of the device 50, and a big drag gesture in the down-right direction may be interpreted as any desired special command.

FIGS. 9E and 9F show examples of the interpretation of the simple drag gestures and drag and hold gestures when in the lowercase mode. The interpretation is the same as for the uppercase mode except that (i) the simple drag gestures generate the lowercase forms of the letters produced by the respective simple drag gestures in the uppercase mode described with reference to FIG. 9A and (ii) the drag and hold gestures generate the uppercase forms of the letters produced by the respective drag and hold gestures in the uppercase mode described with reference to FIG. 9B.

Referring now to the third embodiment of the invention of FIGS. 10A to 14B, the hardware of the third embodiment may be implemented by a modified form of a conventional mobile telephone which is also programmed by software to operate in a different manner to a conventional telephone for the input by the user of letters, numbers and other characters. Referring in particular to FIGS. 10A to 10C, as is conventional, the mobile telephone 70 has a 3×4 array of twelve switches 72 labelled “0” to “9”, “*” and “#” for inputting telephone numbers etc., and a number of other switches 74 used for other purposes, such as initiating a call, hanging up, navigating menus and changing case when inputting text. The telephone also includes a main circuit 26 including a microprocessor 28 and memory 30, to which the display 14, a battery 32, an aerial 34, a microphone 36 and a speaker 38 are connected in a conventional fashion. The main circuit 26 further includes a switchpad interface or decoder 42 to which the switches 72,74 are connected.

Unlike a conventional mobile telephone, the telephone 70 has four additional switches 76 (76nw,76ne,76sw,76se) disposed between (i) the “1”, “2”, “4” and “5” switches 72, (ii) the “2”, “3”, “5” and “6” switches 72, (iii) the “7”, “8”, “*” and “0” switches 72 and (iv) the “8”, “9”, “0” and “#” switches 72, respectively. Furthermore, the interface/decoder 42 is arranged to respond to the simultaneous actuation of two or three of the switches 72,76 and provide a corresponding signal to the microprocessor 28, in addition to being able to respond to the actuation of only one of the switches 72,76 at a particular time.

Similarly to a conventional mobile telephone, the interface/decoder 42 and microprocessor 28 of the telephone 70 are arranged, when in a mode when number input is allowable (for example when dialing a telephone number or when inputting text), to respond to actuation of the switches 72 as shown in the table of FIG. 14A. In the cells of that table, the cross-hatched patches show the effective area over which the user's finger is pressed. Accordingly, the microprocessor interprets actuation of, say, the “6” switch 72 as representing the number “6”. However, unlike a conventional mobile telephone, the interface/decoder 42 and microprocessor 28 of the telephone 70 are arranged, when in a mode when letter and punctuation input is allowable (for example when inputting text), to respond to simultaneous actuation of one of the additional switches 76 in combination with one of, or an adjacent pair of, the switches 72 immediately surrounding that additional switch 76 as shown in the table of FIG. 14B. It will be noted, for example, that simultaneous operation of the top-left additional switch 76nw and the adjacent switch 72 in the up-and-left direction from it (the “1” switch) is interpreted as the letter “A” or “a”, depending upon whether uppercase or lowercase mode has been selected by one of the switches 74. Also, for example, simultaneous operation of the bottom-left additional switch 76sw and the adjacent two switches 72 in the down direction from it (the “*” and “0” switches) is interpreted as the letter “Z” or “z”. In addition to enabling the twenty-six letters of the alphabet to be input, these simultaneous two- and three-switch presses enable five punctuation marks to be input in each case mode, as shown in FIG. 14B, together with a space in response to simultaneous operation of the bottom-right additional switch 76se and the adjacent two switches 72 in the down direction from it (the “0” and “#” switches).

By comparing FIGS. 9A and 14B, the reader will note the correlation between the quadrants 60nw,60ne,60sw,60se of FIG. 9A and the additional switches 76nw,76ne,76sw,76se, respectively, of FIG. 14B, and the correlation between the directions of the simple drag gestures of FIG. 9A and the directions of the required switch or switches 72 from the additional switch 76 in inputting the various letters of the alphabet, punctuation marks and a space. It will also be appreciated from FIG. 14B that the vowels and the semi-vowel Y are input by actuating the two left additional switches 76nw,76sw each in combination with one or both of the switches 72 to the left of that additional switch. With the various combinations of switch actuations to which the processor 28 responds being arranged in the logical fashion of FIG. 14B, the vowels and the half-vowel Y are arranged in order in the left column of the table, and the other letters of the alphabet are arranged in order in rows to the right of the vowel which they follow. It is believed that this arrangement of the switch actuations will facilitate learning.

Referring in particular to FIGS. 12A to 13C, the preferred way of actuating a combination of two or three switches 72,76 when inputting letters into the telephone 70 is as follows. The finger 78 is placed over the appropriate additional switch 76 (if it is not already in that position), and then the finger 78 is pressed against the additional switch 76 whilst simultaneously rolling or tilting the finger 78 in the appropriate one of the eight directions so that the finger 78 also depresses the appropriate switch 72 (FIG. 12C) or two switches 72 (FIG. 13C) to provide the required combination. The interface/decoder 42 is arranged so that when two or three switches 72,76 are pressed within a predetermined time of one another, they are taken to be a combined operation of the switches 72,76, rather than a sequence of operations of individual switches. Each additional switch 76 and its surrounding switches 72 therefore act like a respective eight-way joystick or eight-way rocker switch, but with the user's finger 78 forming the stick of the joystick or the rocker of the rocker switch

Various features may be provided to facilitate the combined operation of two or three of the switches 72,76 in the manner described above. For example, as shown in FIG. 11, the additional switches 76 may be smaller in area than the number switches 72, and the additional switches 76 may stand proud of the number switches 72. The operation of the additional switches 76 may be stiffer than the number switches 72.

Where appropriate, the modifications and developments described above to the first embodiment of the invention may also be applied to the second and third embodiments.

The first to third embodiments of the invention described above can be considered to be three classes of the invention as illustrated schematically in FIGS. 15 to 17 respectively. In the first class, as shown in FIG. 15, there are: four distinct one-of-eight direction-selection systems 80 (embodied by the joysticks 16 of FIGS. 1 to 7C); four distinct direction detection systems 82 (embodied by the switches 20 of the joysticks 16); and a single one-of-four option-detection and decoding system 84 (embodied by the decoder 42). When a user actuates one of the direction-selection systems 80, the respective direction-detection system 82 detects the selected direction, the option-detecting and decoding system 84 detects which of the four direction-detection systems 82 has detected a selected direction and therefore which of four options has been selected by the user, and the option-detecting and decoding system 84 decodes the detected option and the detected direction to produce an output representing a respective letter of the alphabet.

In the second class, as shown in FIG. 16, there are: a direction- and option-selection system 86 (embodied by the touch-sensitive display 54 of FIGS. 8A to 9F) with which the user can select one of four options (i.e. the quadrant 60 in which a gesture is made) and one of eight directions (i.e. the direction in which the gesture is made); a direction- and option-detection system 88 (embodied in part by the interface circuit 58 and in part by the microprocessor 28); and a decoding system 90 (embodied by the microprocessor 28). When a user actuates the direction- and option-selection system 86, the direction- and option-detection system 88 detects the selected option and selected direction, and the decoding system 90 decodes the detected option and detected direction to produce an output representing a respective letter of the alphabet.

In the third class, as shown in FIG. 17, there are: two direction- and option-selection systems 92 (the first embodied by the numeric keys “1” to “6” and additional keys 76nw,76ne, and the second embodied by the numeric keys “7” to “#” and additional keys 76sw,76se of FIGS. 10A to 14B) with each of which the user can select one of two options (i.e. the left additional key 76nw,76sw or the right additional key 76ne,76se) and one of eight directions (i.e. the one or two numeric keys pressed in combination with the additional key); two direction and preliminary option detection systems 94 (embodied by the switches of the numeric keys 72 and additional keys 76); and a final option detection and decoding system 96 (embodied by the decoder 42). When a user actuates one of the direction- and option-selection system 92, the respective direction and preliminary option detection system 94 detects the selected option (left or right) and selected direction, the final option detecting and decoding system 96 detects which of the two direction and preliminary option detection systems 94 has detected a selected direction option and therefore which of four options has been selected by the user (upper or lower, and left or right), and the final option detecting and decoding system 96 decodes the detected option and detected direction to produce an output representing a respective letter of the alphabet.

Other classes of the invention are also possible. For example, FIG. 1S shows a fourth class of the invention which provides a pair of one-of-eight direction selection systems 98 (such as eight-way joysticks) with respective direction detection systems 100 (such as the joystick's switches), a one-of-two option selection system 102 (such as a shift key) with a preliminary option detection system 104 (such as a shift key's switch), and a final option detection and decoding system 106. When a user actuates one of the direction-selection systems 98, the respective direction detection system 100 detects the selected direction. Also, the preliminary option detection system 104 detects the option selected with the one-of-two option selection system 102 (such as shifted, or not shifted). The final option detecting and decoding system 106 detects which of the two direction-detection systems 100 has detected a selected direction, and, from that and from the option detected by the preliminary option detecting system 104, detects which of four options has been selected by the user (shifted or unshifted, and left or right), and the final option detecting and decoding system 106 decodes the detected option and detected direction to produce an output representing a respective letter of the alphabet. In variants of this fourth class of the invention, the direction selection systems 98 and/or direction detection systems 100 may have components in common (similarly to the second and third classes), and the one-of-two option selection system 102 may be combined with the one or both direction selection systems 98 (for example by being provided as a shift button on the top of a joystick).

Furthermore, FIG. 19 shows a fifth class of the invention which has a single one-of-eight direction selection system 108 (such as an eight-way joystick) with a direction detection system 110 (such as the joystick's switches), a one-of-four option selection system 112 (such as four keys which may be operated independently, two keys which may be operated in combination, or a four-way joystick) with an option detection system 114 (such as the keys' switches or the joystick's switches), and a decoding system 116. When a user actuates the direction-selection system 108, the direction detection system 110 detects the selected direction. Also, the option detection system 114 detects the option selected with the one-of-four option selection system 112. The decoding system 116 decodes the detected direction and the detected option to produce an output representing a respective letter of the alphabet.

It should be noted that the embodiments of the invention have been described above purely by way of example and that many other modifications and developments may be made thereto within the scope of the present invention.

1.-16. (canceled)

17. A data input system with which a user can input letters of an alphabet, comprising a keypad having an array of three columns and at least three rows of numeric keys (72), and four further keys (76) each disposed between a respective four of the numeric keys such that the user can operate each of the further keys in combination with one or two of the respective four adjacent surrounding numeric keys; and decoding means (42) operable to interpret operation of the further keys each in combination with one or two of the respective four surrounding numeric keys as representing respective letters of the alphabet.

18. A data input system as claimed in claim 17, wherein the numeric keys are arranged to provide a different feel to the user than the further keys.

19. A data input system as claimed in claim 17, wherein the decoding means is operable to interpret operation of the numeric keys as representing respective digits of the denary number system.

20. (canceled)

21. An electronic apparatus having a data input system with which a user can input letters of an alphabet, the data input system comprising a keypad having an array of three columns and at least three rows of numeric keys (72), and four further keys (76) each disposed between a respective four of the numeric keys such that the user can operate each of the further keys in combination with one or two of the respective four adjacent surrounding numeric keys; and decoding means (42) operable to interpret operation of the further keys each in combination with one or two of the respective four surrounding numeric keys as representing respective letters of the alphabet.

22. An electronic apparatus as claimed in claim 21, wherein the apparatus is selected from the group consisting of a mobile telephone, a PDA and a computer.

23. A data input system as claimed in claim 17, wherein each further key is arranged to be operable by the user in combination with one or two of the respective four adjacent surrounding numeric keys in a single operation, and the decoding means is operable to interpret such single operations of the keys as representing the letters of the alphabet.

24. A data input system as claimed in claim 18, wherein the further keys are each smaller in area than each of the numeric keys.

25. A data input system as claimed in claim 18, wherein the further keys stand proud of the numeric keys.

26. A data input system as claimed in claim 18, wherein operation of the further keys is stiffer than operation of the numeric keys.

27. A data input system as claimed in claim 17, wherein the numeric keys that are operable to represent the vowels of the alphabet are arranged in the same column or the same row of the array.
